(19) United States
(12) Patent Application Publication
(10) Pub. No.: US 2009/0302784 A1
(43) Pub. Date: Dec. 10, 2009

(54) High pressure Discharge Lamp

(76) Inventors: Steffen Franke, Greifswald (DE); Helmut Hess, Berlin (DE); Lothar Hitzschke, Munich (DE); Marko Käning, Haar (DE); Ralf-Peter Methling, Greifswald (DE); Bernhard Schalk, Unterhaching (DE); Hartmut Schneidenbach, Berlin (DE); Heinz Schöpp, Berlin (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/375,409

(22) PCT Filed: Jul. 16, 2007
(86) PCT No.: PCT/EP07/57316

§ 371 Date: Aug. 13, 2009

(30) Foreign Application Priority Data
Jul. 27, 2006 (DE) 10 2006 034 833.8

(51) Int. Cl. H05B 41/36; H01J 61/20; H01J 61/18

(52) U.S. Cl. 315/307; 313/641; 313/638

(57) ABSTRACT

A high-pressure discharge lamp with a discharge vessel comprising electrodes; at least one noble gas as starting gas; at least one element selected from the group consisting of Al, In, Mg, Tl, Hg, Zn for arc transfer and discharge vessel wall heating; and at least one rare-earth halide for the generation of radiation. The lamp is designed in such a way that the light generated is dominated by molecular radiation.

### TECHNICAL FIELD

The present invention relates to a high-pressure discharge lamp.

### PRIOR ART

High-pressure discharge lamps, in particular so-called HID lamps, have long been known. They are used for various purposes, primarily also for applications in which relatively good color rendering and a very good luminous efficiency are required. These two variables are in this case usually interrelated, i.e. an improvement in one variable impairs the other, and vice versa. In general lighting applications, the color rendering is generally more important, but in street lighting, for example, the reverse is true.

High-pressure discharge lamps are also characterized by a high power in comparison with the size of the lamp or with the size of the light-emitting region of the lamp.

Here and in the text below, high-pressure discharge lamps are understood to mean only those lamps which have electrodes within the discharge vessel. There is a very large number of publications and an immense amount of patent literature relating to high-pressure discharge lamps, for example WO 99/05699, WO 98/25294, and Born, M., Plasma Sources Sci. Technol., 11, 2002, A55.

Individual fill components have also been investigated in microwave discharges, for example in the BMBF (Federal Ministry of Education and Research) project, Final Report, FKZ: 13N 7412/6, 2001, pages 3-8, pages 86-87 and pages 89-90. In this case, microwave discharges demonstrate the difference in comparison with discharges using electrodes that the heating of the discharge gas is carried out from the peripheral region out instead of from the inside out. Different temperature profiles are therefore set than in the case of discharges using electrodes.

### DESCRIPTION OF THE INVENTION

As regards these properties, high-pressure discharge lamps have for some time been the subject of constant improvements. The present invention also has the aim of specifying a high-pressure discharge lamp which is improved as regards a good overall combination of luminous efficiency and color rendering properties.

The invention is directed to a high-pressure discharge lamp with a discharge vessel which contains: electrodes, at least one noble gas as starting gas, at least one element selected from the group consisting of Al, Tn, Mg, Tl, Hg, Zn for arc transfer and discharge vessel wall heating and at least one rare-earth halide for the generation of radiation, which is designed in such a way that the light generated is dominated by molecular radiation.

Preferred configurations are specified in the dependent claims and will be likewise explained in more detail below. In this case, the invention relates in particular also to a lighting system comprising the high-pressure discharge lamp together with an appropriate electronic ballast for the operation thereof.

The basic concept of the invention consists in the radiation generated by molecules in the discharge medium being utilized in very dominant fashion in the generation of light of the high-pressure discharge lamp. For this purpose, the rare-earth halide for the radiation generation is provided, with naturally also other constituents of the discharge plasma being capable of being involved in the radiation generation.

Conventional high-pressure discharge lamps are dominated by atomic radiation. Molecular radiation conventionally occurs to a subordinate extent and in this case has a broader-band spectral distribution in comparison with atomic radiation, i.e. can completely fill broader wavelength segments with radiation. In contrast to this, atomic radiation is naturally line radiation, in which, in conventional lamps, a certain improvement in the fundamentally restricted color rendering properties of line radiation is nevertheless achieved as a result of a large number of lines and various broadening mechanisms. In general, however, the segments generated by such mechanisms are markedly smaller than in the case of molecular radiation and, in addition, the line widths of atoms are fixedly correlated with further particle densities in a complicated manner, it being very difficult for particle densities in the lamp to be influenced.

Placing the emphasis on molecules for the radiation economy of the lamp in this case has at the same time the effect of making good absorption properties and therefore greater thermalization possible. The term thermalization is in this case to be understood locally. One refers to local thermodynamic equilibrium since in fact there is naturally no homogeneous temperature distribution.

A lamp according to the invention has a noble gas or noble gas mixture as the starting or buffer gas, with the noble gases Xe, Ar, Kr, and of these very particularly Xe, being preferred. Typical coldfilling partial pressures of the starting gas are in the range of from 10 mbar to 15 bar and preferably between 50 mbar and 10 bar, further preferably between 500 mbar and 5 bar and very particularly preferably between 500 mbar and 2 bar. In addition, an arc transfer and vessel wall heating component is provided which has at least one element from the group consisting of Al, Tn, Mg, Tl, Hg, Zn. In this case, these elements may be present in the form of halides, in particular iodides or bromides, and can also be introduced in this form, for example as AlI₃ or TlI. The starting and buffer gas ensures the coldstarting ability and coldstart ignition of the discharge. After sufficient heating, the arc transfer and vessel wall heating elements, which are present as a chemical compound or, in the case of Al, Mg, In, Hg and Zn, possibly also in elemental form, evaporate The corresponding chemical components in the resultant plasma take on the arc. As a result of the changed plasma properties, the wall temperature increases, and therefore the at least one rare-earth halide also transfers to the vapor phase This rare-earth halide is preferably formed with an element from the group consisting of Tm, Dy, Ce, Ho, Gd, preferably the group consisting of Tm, Dy, and very particularly preferably Tm. As above, these are preferably iodides or bromides. An example is TmI₃. The components which are important for the starting process, i.e. the starting gas and the arc transfer and vessel wall heating elements, now possibly only play a subordinate role in the emission.

In contrast to conventional high-pressure discharge lamps, an arc is now produced which is dominated by the molecular emission in particular of the rare-earth halides. In particular thulium monoiodide TmI comes into consideration, which is formed from the introduced triiodide TmI₃.

In principle, rare-earth elements can be introduced in particular as triiodides, which become diiodides and finally monoiodides as a function of temperature. Particularly effective for the invention are the temporarily formed rare-earth monoiodides or generally monohalides.

The role of the rare-earth halides is not restricted to the generation of the desired continuous radiation. They are at the same time used for arc contraction, i.e. for reducing the temperature in the contraction regions and correspondingly changing the nonreactive resistance of the plasma.

In conventional high-pressure discharge lamps, a distinction is traditionally drawn between so-called voltage formers and light formers. The addition of a special voltage former in the present context is not absolutely necessary and can, in any case above certain quantities, also be counterproductive. Owing to the special formation of the temperature profile in the form of the contracted arc, species contained in the discharge core nevertheless obviously take on a suitable resistance formation of the plasma. In particular, it is also possible to entirely or partially dispense with the conventional voltage formers Hg and Zn, with the invention not being restricted to Hg-free or Zn-free lamps. To be able to omit or at least reduce the Hg constituent forms a marked advantage already in terms of environmental points of view.

The constituents Hg and Zn can, however, play a positive role, for example, even in connection with wall interactions and may nevertheless be desirable for further increasing the lamp voltage and therefore may be included despite the fact that a voltage former can actually be dispensed with.

In order to achieve very good radiation yields, it has conventionally been usual to use atomic radiation, in particular that of Tl and Na. The need to use atomic radiation for achieving high luminous efficiencies is not only not necessary in the present context but, owing to the color rendering properties, is also not desirable in the case of Tl and Na primarily owing to the undesired arc cooling. In particular, the introduction of Na should be refrained from entirely or markedly restricted. The Na radiation in the infrared at approximately 819 nm and further infrared lines of the Na can leave the plasma largely unimpeded, since it is often optically very thin above a limit wavelength, for example above approximately 630 nm, and can cool the arc. Even if the spectral range about the Na resonance line at 589 nm cannot be designated as optically thin, this radiation would also result in undesirable cooling of the central arc regions. Thus, the temperatures in the arc would be reduced in an undesirable manner.

Similar arguments also apply to other species which have significant emission capabilities in the wavelength range of above 580 nm, in particular K and Ca. The constituents Na, K and Ca should therefore preferably be present at most in those quantities which are not relevant to the emissions properties and which do not disrupt the mentioned domination by molecular radiation.

According to the invention, the plasma should be optically thick over a visible spectral range which is as broad as possible. This means that there is further-reaching thermalization of the radiation in comparison with conventional high-pressure discharge lamps prior to the exit of said radiation from the lamp, which produces a desirable approximation to a Planckian spectral distribution. The Planckian spectral distribution corresponds to the idealized blackbody radiator and is found to be “natural” in human sensory perception.

Moreover, the pronounced radiation contributions of the additives Na, K and Ca “bend” the spectra and impair the approximation to the Planckian spectral response. Lines at wavelengths over 600 nm can, however, in principle barely be avoided since in this case the rare-earth halides no longer absorb to a notable extent and also there are no other absorbers available.

The proximity to the Planckian radiation response can be calculated using the so-called chromaticity difference ΔC. The lamp according to the invention should have a good, i.e. a low, ΔC value. When using ceramic discharge vessels, very advantageous values of |ΔC|<10⁻² can be achieved for general lighting purposes.

With the high-pressure discharge lamp according to the invention, good luminous efficiencies can be achieved, to be precise preferably over 90 lm/W. At the same time, the color rendering properties should be good, to be precise preferably with a color rendering index Ra of at least 90.

In specific cases, when implementing the invention, however, one of the two abovementioned aims, the color rendering properties or the luminous efficiency, can be very markedly in the foreground, for example the luminous efficiency in the case of streetlighting. The preferred sector of application of the invention, however, is high-quality general lighting, in which ultimately both variables are of relevance.

The domination by molecular radiation is quantified in a configuration of the invention by a parameter AL, which in this case is referred to as the “atom line component”. Claim 12 specifies the determination of this atom line component AL. It is preferably at most 40%, better 35%, 30% or even at most 25%, to be precise also in the case of quartz discharge vessels. In the case of ceramic discharge vessels, it is particularly preferably at most 20%, better 15% and even at most 10%.

Particular stability in terms of the variation of the power is achieved by a plurality of rare-earth halides being combined in a suitable manner as molecular radiators. In this case, two groups of rare-earth halides are used jointly. A first group has the property that small discrepancies in the power from the working point where ΔC=0 result in higher ΔC values, which transfer with a steep gradient from positive to negative values as the power increases. A particularly suitable representative of this group is Tm halide, in particular TmI₃. A second group has the property that small discrepancies in the power from the working point where Δ=0 result in higher ΔC values, which transfer with a steep gradient from negative to positive values as the power increases. A particularly suitable representative of this group is Dy halide, in particular DyI₃. A further well suited representative of this group is GdI₃, with it being possible for the latter to be used in particular in addition to Dy halide. Particularly well suited is a mixture which contains approximately equal molar quantities of the first and second groups, in particular 25 to 75 mol % of the first group. Particularly preferred is a proportion of 45 to 55 mol % of the first group.

The favorable properties of a lamp according to the invention can be utilized and optimized primarily in conjunction with an electronic ballast, for which reason the invention also relates to a lighting system comprising a lamp according to the invention with an appropriate electronic ballast.

### BRIEF DESCRIPTION OF THE DRAWINGS

FIG. 1 shows a schematic sectional view of a high-pressure discharge lamp according to the invention with a ceramic discharge vessel.

FIG. 2 shows a schematic sectional view of a high-pressure discharge lamp according to the invention with a quartz glass discharge vessel.

FIG. 3 shows a basic circuit diagram with an electronic ballast and a lamp as shown in FIGS. 1 and 2.

FIGS. 4-6 show emission spectra of the lamps from FIGS. 1 and 2.

FIG. 7 shows a graph of the spectral eye sensitivity curve.

FIG. 8 shows the emission spectrum from FIG. 4 in comparison with a Planckian curve.

FIG. 9 shows, in six individual graphs, various characteristic data of the lamp from FIG. 1 depending on the lamp power.

FIGS. 10-11 show the chromaticity discrepancy and color temperature as a function of the power of the lamp for various fills.

FIG. 12 shows the emission spectrum of two fills.

FIGS. 13-16 show the chromaticity discrepancy and color temperature as a function of the power of the lamp for a series of rare earths.

FIG. 17 shows the emission spectrum of a high-pressure discharge lamp with a Tm/Dy mixture.

FIGS. 18-19 show the emission spectrum for two lamps in accordance with the prior art.

### PREFERRED EMBODIMENT OF THE INVENTION

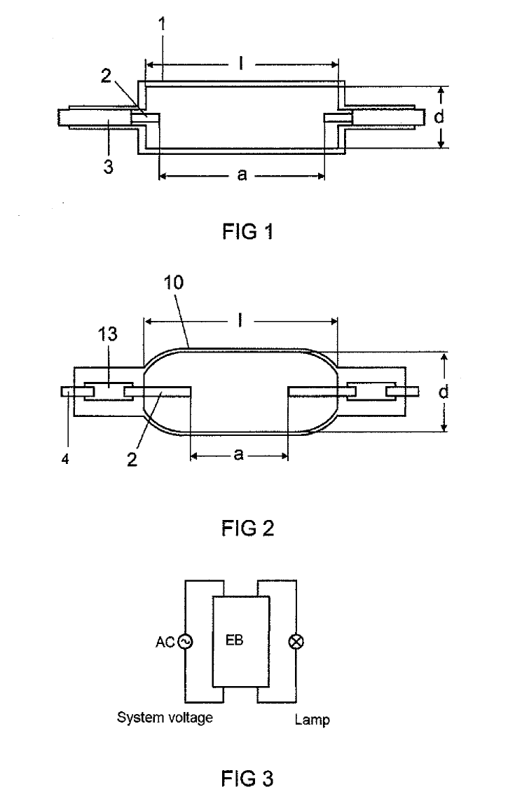

FIG. 1 and FIG. 2 show schematic sectional views of high-pressure discharge lamps according to the invention. FIG. 1 shows a lamp with a discharge vessel 1 consisting of Al₂O₃ ceramic. The flow of current through the arc discharge is made possible by tungsten electrodes 2 fitted on both sides in the discharge vessel, which tungsten electrodes 2 are introduced into the discharge vessel via a leadthrough system 3. The leadthrough system comprises, for example, molybdenum pins and is welded to the electrode and to the outer power supply line (not shown in the figure).

FIG. 2 shows a lamp with a discharge vessel 10 consisting of quartz glass. The tungsten electrodes 2 are in this case welded to a molybdenum foil 13. In the region of this foil, the quartz glass discharge vessel is sealed off by a pinch seal. The molybdenum foils are additionally welded to the respective outer power supply line 4.

The characteristic dimensions of the discharge vessels are the length l, the inner diameter d and the electrode gap a, which will be described in more detail below.

Both the ceramic and the quartz glass discharge vessel are each introduced into an outer bulb (not illustrated) consisting of quartz glass, as is known per se. The outer bulb is evacuated. The power supply lines are passed to the outside from the outer bulb via pinch seals, which tightly seal the outer bulb, and are used for connecting the lamp to the electronic ballast (EB). Said electronic ballast generates from the system voltage the typical square-wave excitation for the operation of high-pressure discharge lamps with a frequency of typically 100 Hz to 400 Hz given a power of 35 W to 400 W (“alternating DC voltage”). A basic circuit diagram with the system voltage denoted by AC for short, the electronic ballast denoted by EB and the lamp is shown in FIG. 3.

The discharge vessel contains a fill with Xe as the starting gas and AlI₃ and TlI as the arc transfer and wall heating elements and TmI₃.

The fill quantities and the characteristic dimensions of the discharge vessel vary depending on the embodiment of the lamp.

Typical examples A1 to A6 are listed in table 1. The Xe pressure specified is the coldfilling pressure. The iodide quantities specified are the absolute quantities added. The above geometry parameters l, d, a are also given. The figure for ΔC is given in thousandths (E-3).

Preferably, the electronic ballast can be designed to excite acoustic resonances by a radiofrequency amplitude modulation being applied in a frequency range of approximately between 20 and 60 kHz. For a more detailed explanation, reference is made by way of example to the patent EP-B 0 785 702 and the references therein. Excitation of acoustic resonances in this form results in the active stabilization of the discharge arc in the plasma, which may be advantageous in particular also in connection with the present invention as a result of the relatively constricted form of the temperature profile.

TABLE 1

| | Material | | | | | | | | Power |
|---|---|---|---|---|---|---|---|---|---|
| | of the | | | | | Atom line | | | per |
| | discharge | | | Electrode | | component | | | wall |
| | vessel | Length l | Diameter d | gap a | Fill | AL | ΔC | Power P | area |
| A1 | Ceramic | 22 | 6 | 19 | 1 bar Xe, | 4% | 0.3E−3 | 180 W | 43 W/cm² |
| | | | | | 2.2 mg AlI₃, | | | | |
| | | | | | 0.5 mg TlI, | | | | |
| | | | | | 3.9 mg TmI₃ | | | | |
| A2 | Ceramic | 13 | 9 | 10 | 1 bar Xe, | 4% | −0.2E−3 | 150 W | 41 W/cm² |
| | | | | | 2 mg AlI₃, | | | | |
| | | | | | 0.5 mg TlI, | | | | |
| | | | | | 16 mg TmI₃ | | | | |
| A3 | Quartz | 24 | 8 | 18 | 1 bar Xe, | 12% | 24E−3 | 150 W | 25 W/cm² |
| | | | | | 2 mg AlI₃, | | | | |
| | | | | | 0.5 mg TlI, | | | | |
| | | | | | 1.1 mg TmI₃ | | | | |
| A4 | Ceramic | 13 | 9 | 10 | 1 bar Xe, | 13% | −0.1E−3 | 200 W | 55 W/cm² |
| | | | | | 2.2 mg AlI₃, | | | | |
| | | | | | 0.5 mg TlI, | | | | |
| | | | | | 4 mg DyI₃ | | | | |
| A5 | Ceramic | 13 | 9 | 10 | 1 bar Xe, | 10% | 7E−3 | 150 W | 41 W/cm² |
| | | | | | 2 mg AlI₃, | | | | |
| | | | | | 8 mg DyI₃, | | | | |
| | | | | | 8 mg CeI₃ | | | | |
| A6 | Ceramic | 13 | 9 | 10 | 1 bar Xe, | 16% | 21E−3 | 324 W | 89 W/cm² |
| | | | | | 2.2 mg AlI₃, | | | | |
| | | | | | 0.5 mg TlI, | | | | |
| | | | | | 4 mg CeI₃ | | | | |

The four last columns in table 1 will be described in more detail below.

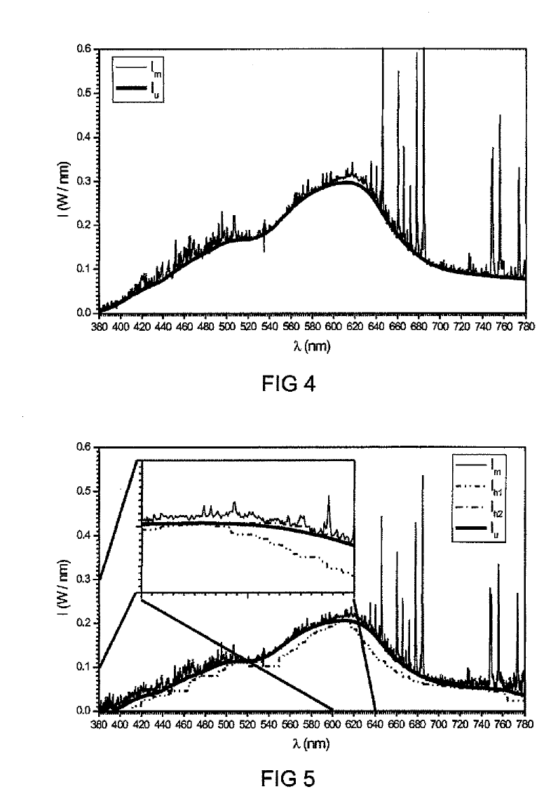

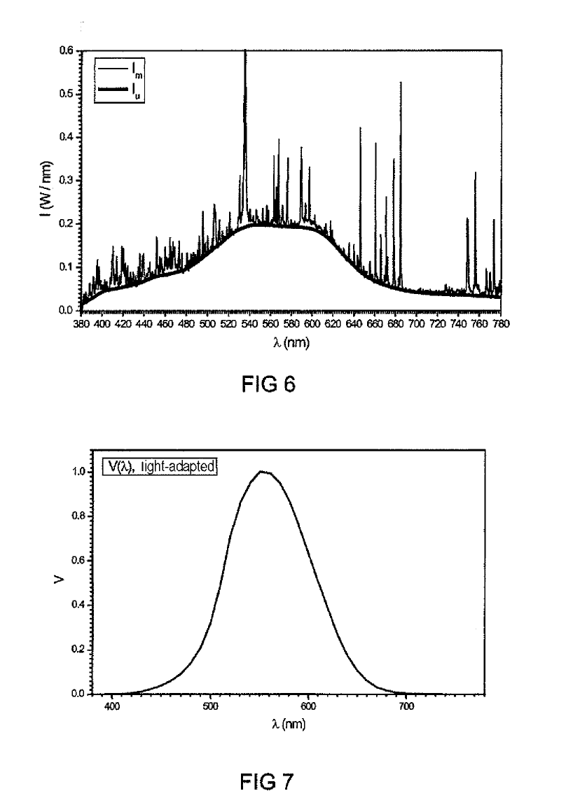

First, emission spectra of the lamps will be illustrated with respect to exemplary embodiments A1, A2 and A3. In this case, the determination of the atom line component AL will also be explained. FIGS. 4, 5 and 6 each relate to exemplary embodiment A1, A2 and A3, respectively, and each show a spectrum of the emission of the lamps from FIG. 1 and FIG. 2 in the visible range between 380 nm and 780 nm, which spectrum is measured with a spectral resolution of 0.3 nm after 10 h operation in an Ulbricht sphere. The vertical axis shows the spectral power density I in mW/nm.

In each case one curve determined in accordance with the following method is superimposed on the line which, as can be seen, is zigzagged corresponding to the resolution, for determining the continuous background. Particularly, reference is made in this regard to the additional graphic explanations in FIG. 5. A curve Iₘ(λ) is present from the measurement. In an interval with a total width of 30 nm around each wavelength value λ corresponding to a measurement, i.e. with in each case 50 measured values on the respective sides, a minimum Iₕ₁(λ) in this interval is associated with each wavelength value. Thus, a smoothed function Iₕ₁(λ) which runs in principle below the measured spectral distribution Iₘ(λ) is provided.

From this a further function Iₕ₂(λ) is determined, with in turn intervals of the same width, i.e. with in total 100 measurement points, being used around each individual wavelength value. In this case, however, in each case the maxima of the function Iₕ₁(λ) in these intervals are used as the function values Iₕ₂. A second function results which comes slightly closer to the measured profile, i.e. runs between the measured profile Iₘ(λ) and the function Tₕ₁(λ) with the minima.

From this, a third function Iᵤ(λ) is determined, with in turn the means of Iₕ₂(λ) this time being determined in the 30 nm width intervals around the respective wavelength values. This smoothes the curve Iₕ₂ markedly and, in this example, results in the smooth lines illustrated in FIGS. 4 to 6.

In principle, this is a relatively simple procedure merely in the form of a model for determining a realistic continuous background, which is nevertheless objective and reproducible.

With the background function Iᵤ(λ) determined and the spectral distribution Iₘ(λ) measured, the atom line component AL can then be determined as:

$$AL = \frac{{\int }_{0}^{∞} V ( λ ) {I}_{m} ( λ ) d λ - {\int }_{0}^{∞} V ( λ ) {I}_{u} ( λ ) d λ}{{\int }_{0}^{∞} V ( λ ) {I}_{m} ( λ ) d λ}$$

In this case, the light-adapted sensitivity of the human eye is also taken into consideration as a weighting function and, as a result, at the same time the integration is also restricted to the visible spectral range. The spectral eye sensitivity V(λ) is shown in FIG. 7.

In order to implement the individual steps for determining Iₕ₁(λ), Iₕ₂(λ) and Iᵤ(λ) as illustrated with the full interval width of 30 nm, measured values below 380 nm and above 780 nm are also required at the edge of the wavelength range.

By means of weighting with the eye sensitivity V(λ), which is equal to zero outside of the wavelength range 380 nm to 780 nm, it is nevertheless sufficient to measure only between 380 nm and 780 nm in order to determine the atom line component AL. During the determination of Iₕ₁(λ), Iₕ₂(λ) and Iᵤ(λ), the interval size then needs to be restricted possibly to the range provided in the measured values in the individual steps. In order to determine the value of Iₕ₁ (390 nm), Iₕ₂ (390 nm) and Iᵤ(390 nm), for example, the interval 375 nm to 450 nm corresponding to the interval width of 30 nm is not used, but only the interval of 380 nm to 405 nm.

As can be seen, for example, in FIG. 4 at 535 nm, absorptions caused by atom lines (in this case it is the T1 line at 535 nm) can result in deep dips in the continuous molecular radiation. These dips occur in so narrow a wavelength range that they do not influence the positive properties of the continuous molecular radiation, such as good color rendering, for example. However, these dips are deeper and actually visible in greater numbers the higher the spectral resolution in the measurement of Iₘ(λ).

If these dips are more dense than the interval width of 30 nm, the background curve Iᵤ(λ) determined in the mentioned manner are erroneously drawn downwards. In order to prevent this, the spectral resolution in the measurement of Iₘ(λ) can be restricted to the range 0.25 nm to 0.35 nm.

The upper limit results from the necessity to select the resolution to be so high that the atom lines can be resolved at all.

If the measurement takes place at a higher spectral resolution than 0.25 nm, the measurement of Iₘ(λ) must be converted to a spectral resolution within the limits of 0.25 nm to 0.35 nm prior to the determination of Iₕ₁(λ), Iₕ₂(λ) and Iᵤ(λ). This can take place, for example, by means of mean value generation over a plurality of adjacent measurement points.

By way of illustration, the atom line component describes, in integrated fashion, that part of the measurement curve which remains above the background curve constructed as described above. In this case, it calculates a relative area ratio with respect to the area below the measurement curve as a whole.

In the present exemplary embodiments, the atom line components are 4% for the ceramic lamps in accordance with exemplary embodiments A1 and A2 and 12% for the quartz lamp in accordance with exemplary embodiment A3. It is thereby demonstrated that, as a result of the molecule dominance according to the invention in the emission, a relatively very large continuous background exists which has significantly reduced the relative importance of the atomic line emission.

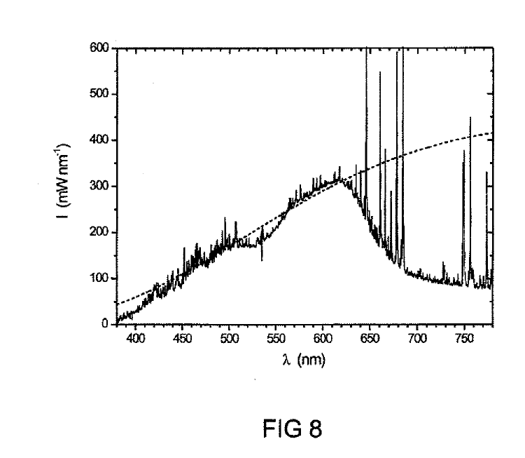

FIG. 8 shows the measurement curve Iₘ(λ) from FIG. 4 together with a superimposed Planckian curve (illustrated by dashed lines) for a blackbody radiator of the temperature 3320 K.

It can be seen that the spectrum up to in the red wavelength range of approximately above 600 nm has a very Planckian response. Quantitatively, this means a size of the chromaticity difference ΔC of 3×10⁻⁴. The luminous efficiency was 94 lm/W given a color rendering index of Ra=92. Thus, this exemplary embodiment is very suitable for general lighting.

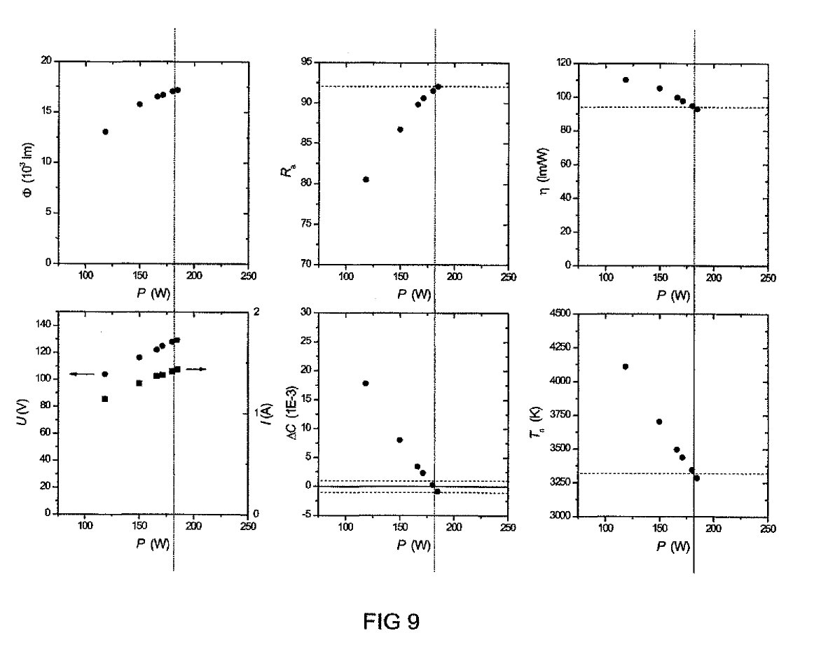

FIG. 9 shows, in six individual graphs, various characteristic data of the lamp A1 used as the exemplary embodiment from FIG. 1 as a function of the lamp power, in each case on the horizontal axis. From left to right there is shown, first at the top the luminous flux Φ, the color rendering index Ra, the luminous efficiency η and at the bottom from left to right the lamp voltage U and the lamp current I, with the lower points illustrated as squares being associated with the right-hand current axis and the upper points being associated with the left-hand voltage axis, the chromaticity difference ΔC and finally the most similar color temperature Tₙ, i.e. the temperature of the blackbody radiator which is most similar in terms of color. It can be seen that in particular the color rendering index and the chromaticity difference are strongly dependent on power and assume particularly good values at values of 180 W. The luminous efficiency is in this case only impaired slightly. It is not recommended here to go markedly beyond 180 W. It can therefore be seen that high-pressure discharge lamps with uncommonly good color rendering properties can be produced with the invention primarily at relatively high powers in relation to the discharge vessel size.

Reference is additionally made to the CIE Technical Report 13.3 (1995) in relation to the variable “chromaticity difference ΔC”. This concerns the evaluation of the quality of the light color of a lamp as regards a sensory perception which is regarded as “natural” by humans. The chromaticity difference is a measure of the proximity of the lamp spectrum to the Planckian radiation response up to a color temperature of 5000 K or up to daylight spectra above this limit. There are application fields in which high values of the chromaticity difference do not have a disruptive effect, but the lamp according to the invention should preferably have a chromaticity difference value in an amount of below 10⁻², better below 5×10⁻² and better still below 2×10⁻³ for more demanding lighting tasks for example in general lighting.

The constituents mentioned in the exemplary embodiment can be replaced in the context of the teaching of this invention by alternatives; for example Xe can also very easily be completely or partially replaced by Ar or else Kr or a noble gas mixture. AlI₃ can be replaced, for example, by InI₃, InI or else by MgI₂, to be precise in turn completely or partially. The rare-earth halide TmT₃ can also be replaced, in particular by CeI₃ or else by other rare-earth iodides or bromides or mixtures.

One advantage of the invention is to be able to dispense with components such as Hg. However, these can also be included. The pronounced contributions to radiation of Na, K and Ca already mentioned should preferably be dispensed with entirely or in any case to such an extent that the described criterion for dominance of the molecular radiation is still met.

The exemplary embodiment contains a small quantity of thallium iodide TlI. Tl is used conventionally for increasing efficiency owing to its resonance line at 535 nm. FIGS. 4 to 6 show that this does not make a substantial contribution to the emission. The function of TlI in this case merely consists in the arc transfer and additional arc stabilization. This constituent should be handled carefully insofar as Tl likewise has lines in the infrared and acts similarly to Na, K or Ca in said range.

The conditions in the lamp should therefore be configured in such a way that the atomic line emission does not play a significant role in a spectral range of the continuum which is as large as possible in the visible range, i.e. the plasma is substantially optically thick in this wavelength range for this radiation or this radiation is generated to a lesser extent. At the same time, the molecular emission of rare-earth halides, in particular monohalides, from the plasma should be promoted to a maximum extent, in particular by virtue of the fact that arc cooling is minimized by emission in the spectral range in which the plasma is no longer sufficiently optically thick. In the present exemplary embodiment, this spectral range extends from 380 nm to approximately 600 nm and is therefore relatively large. Such large ranges are not absolutely essential, however.

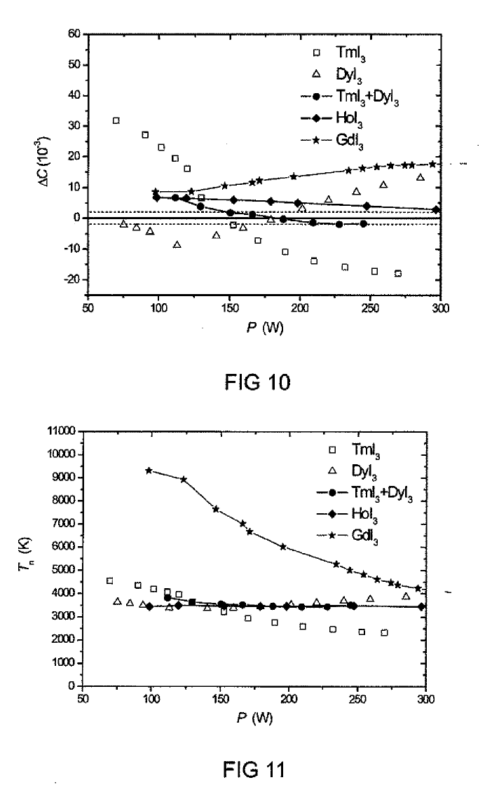

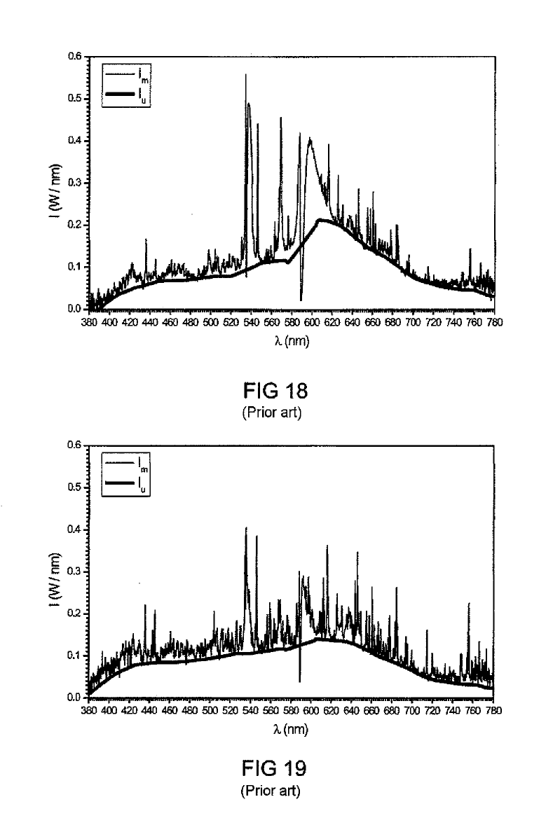

Commercial lamps demonstrate line components of markedly above 20%. One example is shown in FIG. 18. This example is a lamp with a ceramic discharge vessel of the type HCT-TS WDL 150 W (manufacturer OSFAM), which was measured spectrally in an Ulbricht sphere after ten hours' operation. This results in an AL value of 35% for the atom line component. FIG. 10 shows the already described constructed curve for the background.

Another high-pressure discharge lamp with a ceramic discharge vessel of the type CDM-TD 942 150 W (manufacturer Philips) with the spectral distribution as shown in FIG. 19 demonstrates an AL value of 37%.

In a particularly preferred embodiment, the implementation of a molecular-radiation-dominated, preferably Hg-free high-pressure discharge lamp will be described below which is characterized by good efficiency and color rendering over a large power range.

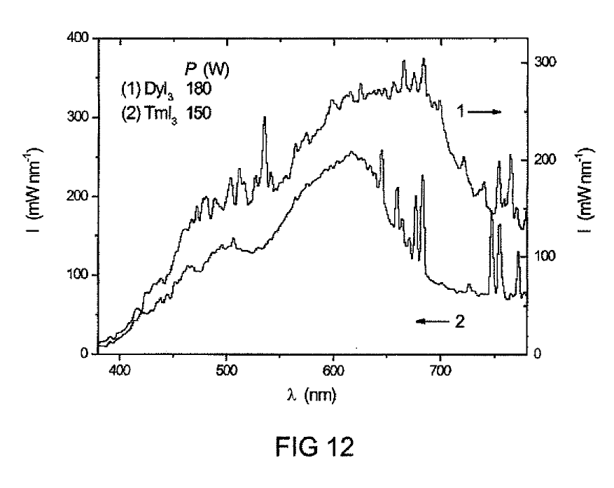

Until now it has been demonstrated that the sole use of, for example, the TmI₃ as the molecular radiator involves a relatively sensitive power dependency of the color gap ΔC. Small discrepancies in the power from the working point where ΔC=0 result in relatively large ΔC values, which transfer at a very steep gradient from positive to negative values as the power increases. A similar response is also found in the case of other rare earths. The use of, for example, DyI₃, on the other hand, results in a ΔC(P) characteristic with which ΔC transfers from negative values to positive values, in sections, as the power increases—in opposition to the characteristic of TmI₃. A similar dependency results for the color temperatures Tₙ(P). Spectra of the respective TmI₃- or DyI₃-containing lamps in the vicinity of the so-called working point (ΔC<2E-3) are illustrated by way of example in FIG. 12. FIGS. 10 and 11 show the characteristics for ΔC and Tₙ. The region of the working point is illustrated by dashed lines.

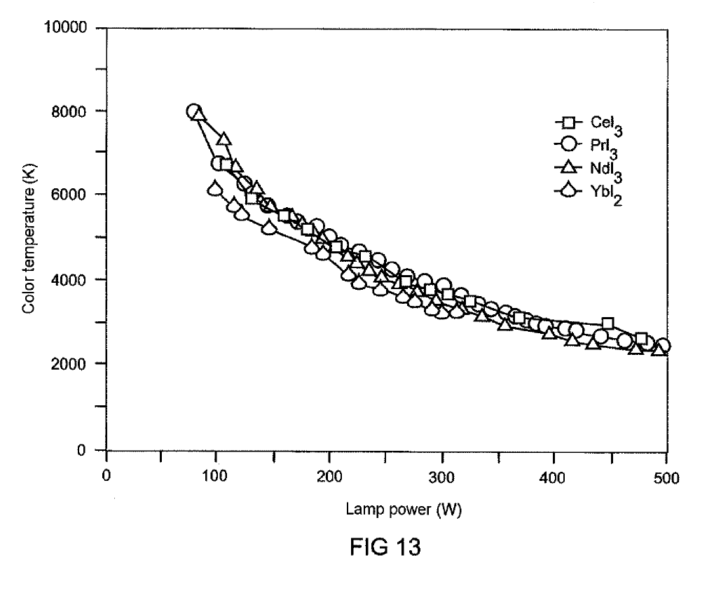

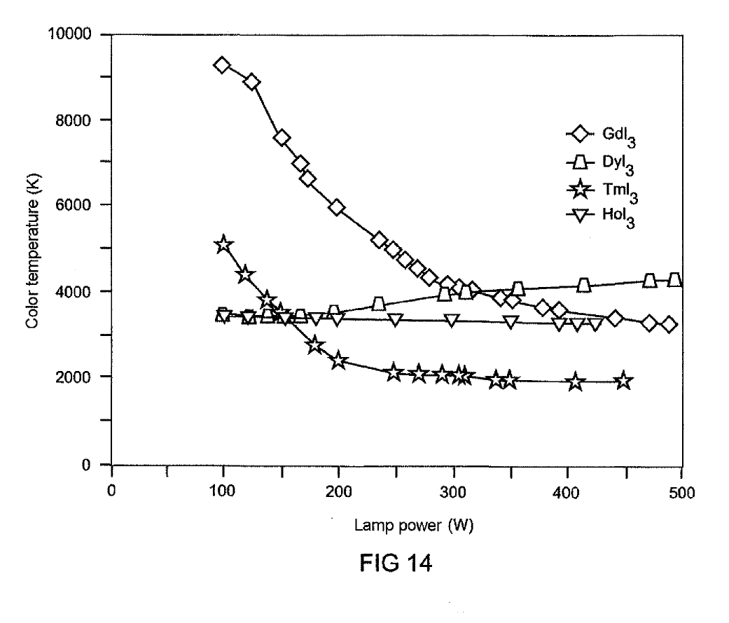

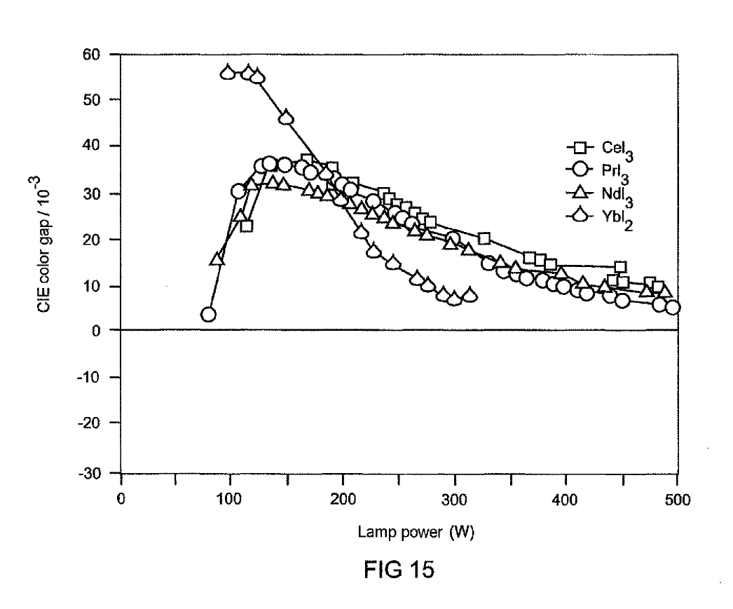

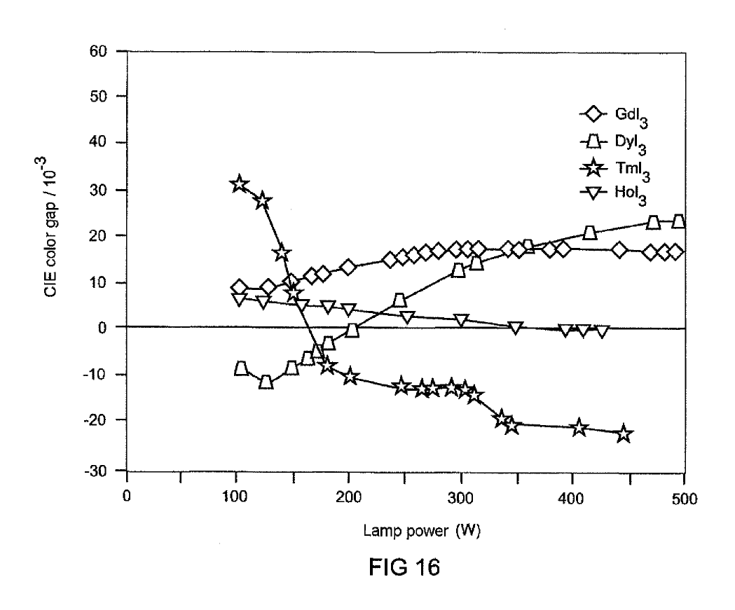

Further exemplary embodiments are shown in FIGS. 13 to 16. Each of these exemplary embodiments involves a high-pressure discharge lamp with a ceramic discharge vessel based on a fill with 1 bar of Xe, 2 mg of AlI₃, 0.5 mg of TlI and a halide of a rare-earth metal. The figures show the response of the rare-earth metals CeI₃, PrI₃, NdI₃, GdI₃, DyI₃, TmI₃, YbI₂, and HoI₃. FIG. 16 shows that primarily Tm and Ho are possible representatives of a first group in which the chromaticity discrepancy ΔC decreases as the power increases because they, in sections, reach values for ΔC of close to zero or, also in sections, have a flat gradient. Further representatives of this group are shown in FIG. 15. These representatives are in particular Pr, Ce and Nd, as well as Yb. Primarily Dy and Gd are possible representatives of a second group in which the chromaticity discrepancy ΔC increases as the power increases; see FIG. 16. The associated color temperature (in kelvin) is shown in FIGS. 13 and 14.

Specific exemplary embodiments which relate to HoI₃ and also GdI₃ are explained in FIGS. 10 and 11. The high-pressure discharge lamp with a ceramic discharge vessel is represented on the basis of a fill of 1 bar of Xe, 2 mg of AlI₃, 0.5 mg of TlI and 4 mg of HoI₃ (example diamond) and on the basis of a fill with 1 bar of Xe, 2 mg of AlI₃, 0.5 mg of TlI and 4 mg of GdI₃ (example star). Specified is in each case ΔC(P) close to zero (ΔC in units of 10⁻³), see FIG. 10, and the color temperature Tn (in K), see FIG. 11. The two variables are specified as a function of the power (P) in the range of 50 to 300 W. Both iodides demonstrate a flat profile of the color gap ΔC(P) in the case of power variation. When using HoI₃ on its own, the color temperature is particularly constant as a function of the power variation.

A suitable combination of TmT₃ and DyT₃ is particularly preferred since it allows the power dependency of ΔC and Tn to be set in a targeted manner given particularly high efficiency. A suitable combination is advantageously a mixture which contains from 25 to 75 mol % of TmI₃, with the remainder being DyI₃. Particularly preferred is a content of 45 to 55 mol % of TmI₃. A specific example with a 1:1 mixture is illustrated in FIG. 10 with respect to the chromaticity discrepancy ΔC and in FIG. 11 with respect to the change in the color temperature. Good results are also provided by an exemplary embodiment in which TmI₃ and HoI₃ together with DyI₃ are used.

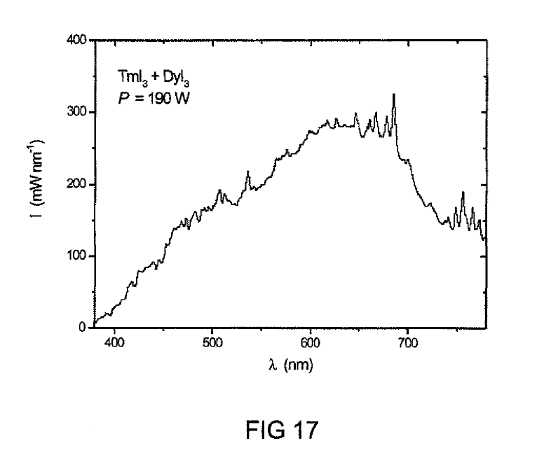

A suitable combination of these two groups of molecular radiators results in spectra which are characterized by a particularly flat profile of ΔC(P) close to zero (ΔC<2E-3), as can be seen in FIGS. 15 and 16. Over a power variation of almost 1:2, a luminous efficiency of over 80 lm/W, a color rendering of Ra≧95, good red rendering with R9=74-95 and a color temperature Tₙ of approximately 3500 K can be achieved; see FIGS. 13 to 14. FIG. 17 shows the emission spectrum of a high-pressure discharge lamp with a Tm/Dy mixture as specifically described in FIGS. 10 and 11.

The most important parameters of the cylindrical ceramic discharge vessel used for the exemplary embodiment (see FIG. 1) are the inner diameter (d=9.1 mm), the inner length (l=13 mm) and the electrode gap (a 10 mm).

The fills of the lamps all contained 1 bar of Xe (coldfilling pressure), 2 mg of AlI₃ and 0.5 mg of TlI. In addition, in each case 4 mg of TmI₃, 4 mg of DyI₃ and, respectively, 2 mg of TmI₃+2 mg of DyI₃ as the dominant molecular radiator were added to the lamps. Instead of DyI₃ or else in addition to DyI₃, GdI₃ can preferably be used.

1. A high-pressure discharge lamp with a discharge vessel comprising:
electrodes;
at least one noble gas as starting gas;
at least one element selected from the group consisting of Al, In, Mg, Tl, Hg, Zn for arc transfer and discharge vessel wall heating; and
at least one rare-earth halide for the generation of radiation,
wherein the light generated by the lamp is dominated by molecular radiation.

2. The high-pressure discharge lamp as claimed in claim 1, in which the noble gas is at least one noble gas selected from the group consisting of Xe, Ar, Kr.

3. The high-pressure discharge lamp as claimed in claim 2, in which the coldfilling partial pressure of the noble gas is between 500 mbar and 5 bar.

4. The high-pressure discharge lamp as claimed in claim 1, wherein the arc transfer and discharge vessel wall heating element is at least one element selected from the group consisting of Al, In, Mg.

5. The high-pressure discharge lamp as claimed in claim 1, wherein the rare-earth halide contains at least one element selected from the group consisting of Tm, Dy, Ce, Ho, Gd.

6. The high-pressure discharge lamp as claimed in claim 4, wherein the arc transfer and discharge vessel wall heating element and/or the rare-earth element was introduced in the form of an iodide or bromide.

7. The high-pressure discharge lamp as claimed in claim 1, wherein the discharge vessel does not contain a quantity of Na which is relevant to the emission properties.

8. The high-pressure discharge lamp as claimed in claim 1, wherein the discharge vessel does not contain a quantity of CaI₂ or K which is relevant to the emission properties.

9. The high-pressure discharge lamp as claimed in claim 1, wherein the discharge vessel consists of ceramic and the following applies for the chromaticity difference ΔC:|ΔC|<10⁻².

10. The high-pressure discharge lamp as claimed in claim 1, wherein the following applies for the luminous efficiency η: η>90 lm/W.

11. The high-pressure discharge lamp as claimed in claim 1, wherein the following applies for the color rendering index Ra:Ra≧90.

12. The high-pressure discharge lamp as claimed in claim 1, wherein the following applies for the atom line component AL:AL≦40%,
where the following applies:
$$AL = \frac{{\int }_{0}^{∞} V ( λ ) {I}_{m} ( λ ) d λ - {\int }_{0}^{∞} V ( λ ) {I}_{u} ( λ ) d λ}{{\int }_{0}^{∞} V ( λ ) {I}_{m} ( λ ) d λ}$$
in which:
V(λ) is the light-adapted eye sensitivity of the human eye,
Iₘ(λ) is the spectral intensity distribution of the high-pressure discharge lamp which is measured in a measurement in an Ulbricht sphere with a resolution of between 0.35 nm and 0.25 nm, inclusive, or converted at a relatively high measurement resolution to a resolution in this range by means of mean value generation, and
Iᵤ(λ) is a model function approximating the continuous background of the measured intensity profile Iₘ(λ), which model function is determined by
1. determination of a function Iₕ₁(λ) with the minima of Iₘ(λ) present in intervals with a width of 30 nm around the respective wavelength value,
2. determination of a further function Iₕ₂(λ) with the maxima of Iₕ₁(λ) present in the intervals with a width of 30 nm around the respective wavelength value, and
3. determination of the function Iᵤ(λ) with the respective arithmetic means of Iₕ₂(λ) present in the intervals with a width of 30 nm around the respective wavelength value.

13. The high-pressure discharge lamp as claimed in claim 12, wherein the discharge vessel consists of ceramic and the following applies for AL:AL≦20%.

14. The high-pressure discharge lamp as claimed in claim 12, wherein the discharge vessel consists of quartz glass and the following applies for AL:AL≦30%.

15. A lighting system with a high-pressure discharge lamp as claimed in claim 1 and an electronic ballast for operating the high-pressure discharge lamp.
